(19) United States
(12) Patent Application Publication
(10) Pub. No.: US 2013/0062516 A1
(43) Pub. Date: Mar. 14, 2013

(54) DIGANOSIS OF A RENAL DISEASE BY OXYGEN AND HYDROGEN ISOTOPES IN A BIOLOGICAL SAMPLE

(71) Applicants: HSIEN-SHOU KUO, TAIPEI CITY (TW); YUAN-HAU LIN, TAIPEI CITY (TW)

(72) Inventors: HSIEN-SHOU KUO, TAIPEI CITY (TW); YUAN-HAU LIN, TAIPEI CITY (TW)

(21) Appl. No.: 13/229,305

(22) Filed: Sep. 9, 2011

(51) Int. Cl. H01J 49/26

(52) U.S. Cl. 250/282; 250/288

(57) ABSTRACT

The invention provides a method for diagnosing likelihood of a renal disease in a subject suspected of the renal disease, comprising: measuring a value of delta O-18 (δ¹⁸O) and/or delta H-2 (δ²H) in a biological sample of the subject suspected of the renal disease, comparing the measured value of delta O-18 and/or delta H-2 with a reference value of delta O-18 and/or delta H-2 obtained from a subject without a renal disease; and diagnosing the likelihood of a renal disease based on the comparison of the measured value of delta O-18 and/or delta H-2 with the reference value of delta O-18 and/or delta H-2, wherein the likelihood of a renal disease is diagnosed when the value of delta O-18 and/or delta H-2 in the biological sample of the subject suspected of the renal disease is lower than the reference value of delta O-18 and/or delta H-2 obtained from a subject without a renal disease. Also provided is a kit for carrying out the method of the invention.

### FIELD OF THE INVENTION

The invention relates to a diagnosis of a renal disease. Particularly, the invention uses the delta H-2 (δ2H) and/or delta O-18 (δ18O) values in biological sample as the basis of the diagnosis of a renal disease.

### BACKGROUND OF THE INVENTION

The kidney is either one or a pair of organs in the dorsal region of the vertebrate abdominal cavity, functioning to maintain proper water and electrolyte balance, regulate acid-base concentration, and filter the blood of metabolic wastes, which are excreted as urine. Thus, the consequence of a kidney disorder can constitute an overall imbalance in the organism as a whole. Many organs such as the bladder, intestine, heart, lungs and prostate depend on the ability of the kidney to filter out the undesirable debris of the body and maintain overall homeostasis.

Kidneys are essentially blood-cleansing organs. The renal artery from the heart brings blood into the kidneys to be cleaned by a network of millions of glomerulus containing nephrons. The nephrons filter out toxins, excess nutrients and body fluid. The remaining cleaned and filtered blood then passes through the renal veins back into circulation. The filtered out material travels down a tubule that adjusts the level of salts, water and wastes that are excreted in the urine. The renal pelvis collects the urine. From the pelvis, urine travels down the ureter to the urinary bladder. The urine is expelled from the bladder and out of the body through the urethra.

Types of kidney disease include diabetes, high blood pressure, glomerulonephritis and cysts. Diabetes affects the body's ability to regulate glucose. Excess glucose in the blood can damage the nephrons in the kidneys reducing the blood vessels' ability to filter toxins. High blood pressure can also damage the nephrons. Glomerulonephritis generally relates to a class of other diseases not related to kidney infection.

If both kidneys stop functioning due to disease, patients experience end-stage renal disease (ESRD), or total kidney failure. Kidney failure means that the body can no longer rid itself of certain toxins and cannot properly regulate blood pressure and critical nutrients. Unless those experiencing kidney failure are treated, they can die within days due to the build-up of toxins and fluid in their blood.

Diabetic kidney disease, also known as diabetic nephropathy, is an important cause of excess morbidity and premature mortality in individuals with type 1 diabetes mellitus (T1DM). Approximately 25% to 40% of patients with T1DM ultimately develop diabetic nephropathy. The most serious long-term effect of diabetic nephropathy is kidney failure leading to end stage renal disease (ESRD), a condition in which there is a permanent and almost complete loss of kidney function, with the kidneys functioning at less than 10% of baseline function. Other causes of ESRD include high blood pressure, glomerulonephritis, polycystic kidneys, interstitial disease, obstructive uropathy, systemic lupus erythematosus, and multiple myeloma.

Conventional method known in the art for diagnosing renal dysfunction involve detection of specific proteins. U.S. Pat. No. 7,141,382 concerns methods of detecting interleukin 18, in a sample, preferably prior to the increase in serum creatinine in a subject predisposed to a condition such as renal failure. U.S. Pat. No. 7,935,495 provides a method for the detection of early renal disease in animals, including the steps of (a) obtaining a sample from an animal to be tested and (b) determining the amount of albumin in the sample. U.S. Pat. No. 7,833,732 relates to a new and useful biomarker, GRO-alpha (i.e., CXCL1, chemokine C—X—C ligand 1, GRO1, GROa, MGSA, MGSA alpha, MGSA-a, NAP-3, SCYB1), for acute kidney injury (i.e., AKI), renal ischemia reperfusion injury (i.e., IRI), ischemic acute kidney injury, and/or ischemic acute tubular necrosis. Although numbers of methods are known for diagnosing renal dysfunction by determining components in a urine or a blood sample, such methods are disadvantageous in that they involve complicated steps to obtain the results of the determination.

Water (H₂O) is the base of life, yet the most important and the most abundant substance in human body, making up about seventy percent of body mass. Despite the notice of the importance of water, an often overlooked facet is the uniqueness of the water isotopes. Natural water contains trace amount of heavy isotope hydrogen and oxygen atoms, and among which the ²H and ¹⁸O are the major ones. The ratio of ¹H to ²H is about 6240 to 1, or about 155 ppm in the V-SMOW (Vienna Standard Mean Ocean Water) water standard, and the ratio of ¹⁶O to ¹⁸O is about 499 to 1, or about 2005 ppm. The unique disposition of isotope water and thanks to the rapid advancement of the mass spectrometry technology, the stable isotopic ratios of hydrogen (δ²H) and oxygen (δ¹⁸O) in various biological tissues have been used as “atomic fossils or tracers” in paleodietary, meteorology, anthropology, ecology, and modern food-chained network.

The stable nonradioactive isotope water, ²H₂O, could play important roles in human physiology and pathophysiology. Several studies using model animals and cell cultures have shown that the augment or depletion of ²H₂O in the dietary water has prominent effects on pathophysiology and physiology. For example, it was previously shown that the ²H₂O can promote the formation of microtubules by stimulating the polymerization of tubulin subunits, and result in cell death. In addition, the increase of ²H₂O content can prevent hypertension in the spontaneous hypertension rat. On the other hand, the depletion of deuterium in the water of culture medium reduces the growth rates of different animal cell lines. It was also showed that the signatures of hydrogen (δ²H) and oxygen (δ¹⁸O) isotope ratios in the body water of an untreated streptozotocin-induced diabetes mellitus are distinct from those of the normal mice.

However, there is no any prior art references disclosing, teaching or suggesting relationship between water isotopes and renal function.

### SUMMARY OF THE INVENTION

The invention relate to method for diagnosing likelihood of a renal disease in a subject suspected of the renal disease, comprising: measuring a value of delta O-18 (δ¹⁸O) and/or delta H-2 (δ²H) in a biological sample of the subject suspected of the renal disease, comparing the measured value of delta O-18 and/or delta H-2 with a reference value of delta O-18 and/or delta H-2 obtained from a subject without a renal disease; and diagnosing the likelihood of a renal disease based on the comparison of the measured value of delta O-18 and/or delta H-2 with the reference value of delta O-18 and/or delta H-2, wherein the likelihood of a renal disease is diagnosed when the value of delta O-18 and/or delta H-2 in the biological sample of the subject suspected of the renal disease is lower than the reference value of delta O-18 and/or delta H-2 obtained from a subject without a renal disease.

The invention also relates to a kit for carrying out the method of the invention.

### DETAILED DESCRIPTION OF THE INVENTION

The invention surprisingly discovers that the delta H-2 (δ2H) and/or delta O-18 (δ18O) values in biological sample are associated with the renal conditions. Accordingly, the invention develops a method for diagnosing a renal disease based on the comparison between the value of the delta H-2 (δ2H) and/or delta O-18 (δ18O) in biological sample from a subject assuming having a potential renal disease and that in a control without a renal disease.

Unless otherwise defined, all technical and scientific terms used herein have the same meaning as commonly understood by one of ordinary skill in the art to which this invention pertains. All publications, patent applications, patents, and other references mentioned herein are incorporated by reference in their entirety. In case of conflict, the present specification, including definitions, will control. In addition, the materials, methods, and examples are illustrative only and not intended to be limiting.

The term “detecting” or “diagnosing” refers to identifying a patient with renal disease and/or a patient who is at risk for having a renal disease.

The term “assay” means an analysis done on a sample to determine the presence of a substance and/or the amount of that substance in the sample.

The term “decreased amount” means an amount that is lower as compared to a predetermined level.

The term “renal disease” means the disorder, impairment, abnormal condition or dysfunction of an individual's renal function.

The term “sample” means a body fluid or tissue fluid sample obtained from a mammalian subject. As a non-limiting example, a body fluid or tissue fluid sample for use in the present invention can be urine, blood, serum, plasma, saliva, lymph, cerebrospinal fluid, cystic fluid, ascites, stool, bile, tissue fluid, and any other isolatable body fluid.

All publications and patent documents cited in this application are incorporated by reference in their entirety for all purposes to the same extent as if each individual publication or patent document were so denoted. By their citation of various references in this document, Applicants do not admit any particular reference is “prior art” to their invention.

In one aspect, the invention provides a method for diagnosing likelihood of a renal disease in a subject suspected of the renal disease, comprising: measuring a value of delta O-18 (δ¹⁸O) and/or delta H-2 (δ²H) in a biological sample of the subject suspected of the renal disease, comparing the measured value of delta O-18 and/or delta H-2 with a reference value of delta O-18 and/or delta H-2 obtained from a subject without a renal disease; and diagnosing the likelihood of a renal disease based on the comparison of the measured value of delta O-18 and/or delta H-2 with the reference value of delta O-18 and/or delta H-2, wherein the likelihood of a renal disease is diagnosed when the value of delta O-18 and/or delta H-2 in the biological sample of the subject suspected of the renal disease is lower than the reference value of delta O-18 and/or delta H-2 obtained from a subject without a renal disease.

Any mammalian subject can be tested in accordance with the inventive method. Typically, however, the test subject (or patient) suffers from renal dysfunction, for example, end stage renal disease (ESRD), nephropathy, renal failure, hyperuricemia, diabetic kidney disease, ischemic or toxicant-induced renal injury, chronic renal failure, acute renal failure, glomerulonephritis, polycystic kidney disease or chronic pyelonephritis. Preferably, the mammalian subject is human, pig, horse, dog, sheep, cattle, goat or cat.

The invention surprisingly found the existence of the biological homeostasis of water isotopes in healthy subjects. The water status (δ18O and δ2H) in healthy subjects is significantly distinct from the subjects with renal disease. It is highly interesting that delta O-18 and/or delta H-2 in the subject with renal disease is decreased.

The reference value with which the value of delta O-18 and/or delta H-2 in a sample is compared is obtained from a subject who does not have any renal disease (a healthy subject). A renal disease can then be diagnosed by way of a decreased level of the delta O-18 and/or delta H-2 in the body liquid sample of the subject to be examined, e.g. a subject who is suspected to suffer from renal disease.

The method according to the invention is also suitable for the routine analysis of healthy subjects, i.e. analyses which are carried out annually so as to diagnose renal disease in a very early stage.

The optimum “control” reference value is a reference value obtained from the same or other subject at a healthy stage. Particularly, the isotopic ratios are expressed as the δ-notation (‰) relative to the international V-SMOW (Vienna Standard Mean Ocean Water) standard and normalized on the scale that the δ 180 and δ2H of SLAP (Standard Light Antarctic Precipitation) are −55.5‰ and −428‰, respectively (Gonfiantini R (1978) Standards for stable isotope measurements in natural compounds. Nature 271: 534-536). According to the invention, the delta O-18 of the subject without a renal disease (i.e., the reference value) ranges from about −3 ‰ to about −7‰; preferably, the value of delta O-18 is about −3‰ to about −6‰, about −4‰ to about −7‰, about −4‰ to about −6‰, about −4‰ to about −5‰ or about −4.5‰ to about −5‰. More preferably, the value of delta O-18 is about −4.7‰, about −4.71‰, about −4.72‰, about −4.73‰, about −4.74‰, about −4.75‰ or about −4.76‰, about −4.77‰, about −4.78‰ or about −4.79‰. The value of the delta H-2 of the subject without a renal disease ranges from about −30‰ to about −40‰, about −30‰ to about −39‰, about −30‰ to about −38‰, about −30‰ to about −37‰, about −30‰ to about −36‰, about −30‰ to about −45‰, about −31‰ to about −40‰, about −32‰ to about −40‰, about −32‰ to about −37‰ or −33‰ to about −37‰. More preferably, the value of the delta H-2 is about −35‰.

According to the invention, since the water isotopes is decreased in the diagnosis of a renal disease. That is, the value of the delta O-18 and/or delta H-2 of the subject with a renal disease is lower than that of the subject without a renal disease. According to the invention, the delta O-18 of the subject with a renal disease is lower than about −3‰, about −4‰, about −5‰, about −6‰, about −7‰. More preferably, the value of the delta O-18 is lower than about −3‰ to about −7‰; preferably, about −3‰ to about −6‰, about −4‰ to about −7‰, about −4‰ to about −6‰, about −4‰ to about −5‰ or about −4.5‰ to about −5‰; more preferably, about −4.7‰, about −4.71‰, about −4.72‰, about −4.73‰, about −4.74‰, about −4.75‰ or about −4.76‰, about −4.77‰, about −4.78‰ or about −4.79‰. Preferably, the value of delta O-18 is about −3‰ to about −18‰, about −4‰ to about −18‰, about −5‰ to about −18‰, about −6‰ to about −18‰, about −7‰ to about −18‰, about −4‰ to about 17‰, about −5‰ to about −17‰, about −6‰ to about −17‰, about −7‰ to about −17‰.

According to the invention, the value of the delta H-2 of the subject with a renal disease is lower than about −30‰, about −31‰, about −32‰, about −33‰, about −34‰, about −35‰, about −36‰, about −37‰, about −38‰, about −39‰, or about −40‰. More preferably, the value of the delta H-2 is lower than −30‰ to about −40‰, about −30‰ to about −39‰, about −30‰ to about −38‰, about −30‰ to about −37‰, about −30‰ to about −36‰, about −30‰ to about −45‰, about −31‰ to about −40‰, about −32‰ to about −40‰, about −32‰ to about −37‰ or −33‰ to about −37‰. More preferably, the value of the delta H-2 is about −30‰ to about −85‰, about −30‰ to about −80‰, about −30‰ to about −75‰, about −30‰ to about −70‰, about −30‰ to about −65‰, about −30‰ to about −60‰, about −30‰ to about −55‰, about −30‰ to about −50‰, about −30‰ to about −45‰, about −30‰ to about −40‰, about −31‰ to about −80‰, about −32‰ to about −80‰, about −33‰ to about −80‰, about −34‰ to about −80‰, about −35‰ to about −80‰, about −35‰ to about −75‰, about −40‰ to about −80‰ or about −40‰ to about −75‰.

According to the invention, the biological sample is a body fluid. More preferably, the body fluid is urine, blood, serum, plasma, saliva, lymph, cerebrospinal fluid, cystic fluid, ascites, stool, bile, tissue fluid, and any other isolatable body fluid. According to the invention, the water to be measured for the isotopes therein are obtained by placing the body fluid sample into a sealed container with a desiccant so that the water in the sample are absorbed by the desiccant to obtain pure water without other components and then removing the water from the hydrated desiccant. Preferably, the removal of the water from the hydrated desiccant is through distillation; more preferably, vacuum distillation. According to the invention, the desiccant is selected from the group consisting of silica gel, activated charcoal, calcium sulfate, calcium chloride, montmorillonite clay, and molecular sieves.

According to a further aspect, the present invention also relates to a kit for carrying out the inventive method, said kit comprising: a vessel containing a biological sample from a subject potentially suffering from a renal disease or who runs the risk of a renal disease, or a vessel assumed to be filled with this sample, a means for measuring the value of the delta O-18 or delta H-2 in a biological sample, and a reference value means for enabling the diagnosis of a renal disease. Preferably, the kit further comprises a vessel containing a desiccant.

The means for measuring the value of the delta O-18 or delta H-2 can be selected from any suitable means for proving/quantifying the delta O-18 or delta H-2, e.g., isotope ratio mass spectrometer.

The means of the reference level which allows for diagnosing a renal disease is preferably selected from a vessel with a biological sample from a healthy human. A calibration curve, instructions for using the kit, or combinations thereof can be further included. With the kit, preferably also suitable instructions (e.g. in written form) should be provided, giving specific information as regards the diagnosis of a renal disease.

The invention studies the stable isotopic ratios of hydrogen (δ2H) and oxygen (δ18O) in a biological sample. It is observed that the δ2H and the δ18O in a biological sample (such as blood plasma) are associated with the human renal functions. Particularly, the δ18O in the blood plasma of the control subjects and diabetes subjects (without renal dysfunction) are 87% and 160% higher than the end stage renal disease subjects (renal dysfunction cases), respectively. The δ2H in blood plasma of the healthy kidney groups (the control subjects and the diabetes subjects) are 72% and 92% higher than the renal dysfunction group. However the blood plasma water contents (δ2H and δ18O) in the control subjects and the diabetes patients have no difference.

### EXAMPLE

While the invention has been described with reference to specific embodiments, it will be understood by those skilled in the art that various changes may be made and equivalents may be substituted for elements thereof to adapt to particular situations without departing from the scope of the invention. The following experimental examples are provided in order to demonstrate and further illustrate various aspects of certain embodiments of the present invention and are not to be construed as limiting the scope thereof. In the experimental disclosure which follows, the following materials and methods are used:

Participants.

According to the biochemical parameters and doctor descriptions on the participants' records, the participants were classified into three categories, the control subject (CS), the patients diagnosed with the end stage renal disease (ESRD), and the individuals with diabetes yet without detectable renal dysfunction (DB). All the DB subjects are under diabetes control. All forty eight subjects (5 CSs, 32 ESRDs, and 5 DBs) are native Taiwanese, live in the Taipei city. They had not traveled abroad for at least three months prior to the sampling date. Thus we can eliminate the isotope ratio variations caused by the geographical isotopic compositions of food and water (Bowen G J, Wilkinson B (2002) Spatial distribution of delta O-18 in meteoric precipitation. Geology 30: 315-318; Hobson K A, Atwell L, Wassenaar L I (1999) Influence of drinking water and diet on the stable-hydrogen isotope ratios of animal tissue, Proc Natl Acad Sci USA 96: 8003-8006; Bowen G J, Ehleringer J R, Chesson L A, Thompson A H, Podlesak D W, et al. (2009) Dietary and physiological controls on the hydrogen and oxygen isotope ratios of hair from mid-20th century indigenous populations. Am J Phys Anthropol 139: 494-504; Chesson L A, Podlesak D W, Erkkila B R, Cerling T E, Ehleringer J R (2010) Isotopic consequences of consumer food choice: Hydrogen and oxygen stable isotope ratios in foods from fast food restaurants versus supermarkets. Food Chemistry 119: 1250-1256).

Water Samples.

3 ml of human blood plasma sample is stored in a 15 ml falcon tube. The tube is then placed into a pre-dried vacuumed round bottle flask with 15 g of CaCl₂ granule (Sigma-Aldrich). The round bottle flask is then capped and sealed carefully to make sure no water in air gets into the flask. The flask is incubated at room temperature for CaCl₂ to absorb water from the human blood plasma sample for seven days. The water sample (about 2 ml) is obtained from the hydrated CaCl₂ by vacuum distillation (Buchi Glass Oven B-585, Kugelrohr).

Determination of Hydrogen (δ²H) and Oxygen (δ¹⁸O) in Human Blood Plasma.

The assessment of hydrogen (δ²H) and oxygen (δ¹⁸O) in the water samples was conducted as the following. The stable oxygen isotopic compositions were analyzed by the well-known CO₂—H₂O equilibration method (Epstein S, Mayeda T (1953) Variation of O18 content of waters from natural sources. Geochimica et Cosmochimica Acta 4: 213-224; Brenninkmeijer C A M, Morrison P D (1987) An automated system for isotopic equilibration of CO2 and H2O for 18O analysis of water. Chemical Geology: Isotope Geoscience section 66: 21-26). The equilibrated CO₂ gas was measured by a VG SIRA 10 isotope ratio mass spectrometer. The hydrogen isotopic compositions were determined on a VG MM602D isotope ratio mass spectrometer after reduction of water to H₂ using Zinc shots made by Biogeochemical Laboratory of Indiana University (Coleman M L, Shepherd T J, Durham J J, Rouse J E, Moore G R (1982) Reduction of water with zinc for hydrogen isotope analysis. Analytical Chemistry 54: 993-995). All isotopic ratio results are reported as the δ-notation (%) relative to the international V-SMOW (Vienna Standard Mean Ocean Water) standard and normalized on the scale that the δ¹⁸O and δ²H of SLAP (Standard Light Antarctic Precipitation) are −55.5‰ and −428‰, respectively (Gonfiantini R (1978) Standards for stable isotope measurements in natural compounds. Nature 271: 534-536). The analytical precisions expressed as 1σ for the laboratory standards are better than 1.3‰ for δ²H and 0.08‰ for δ¹⁸O, respectively. The average differences of duplicate analyses of water samples are ±1.5‰ for δ²H and ±0.11‰ for δ¹⁸O, respectively.

Date Analysis.

The ANOVA and the Student's t-test were performed by using the STASTISTICA 8.0 (StartSoft. Inc., Tulsa, Okla.). The k-means clustering was performed in the MATLAB R2011a (MathWorks. Inc., Natick, Mass.) that data are partitioned into a preset of four clusters. Euclidean distance is measured to compute the centroid of cluster, a mean of the data points within that cluster. A total number of 10,000 repeated clustering processes were performed, as a new set of initial cluster centroid position was given in each round. This procedure returns the best solution of a four clusters that each cluster is with the lowest value of sum of point-to-centroid distances.

### Example 1

### Diagnosis of a Renal Disease Using the Method of the Invention

The stable isotope ratios of hydrogen (δ²H) and oxygen (δ¹⁸O) from 42 human blood plasma's water samples were measured. The samples were randomly obtained from four groups of participants, the fasting control subjects (CS, n=5), the fasting end stage renal disease subjects without haemodialysis treatment (ESRD_{nHD}, n=5), the fasting end stage renal disease subjects with the haemodialysis treatment (ESRD_{HD}, n=27), and the fasting diabetes subjects (DB, n=5).

### The Control Subject Groups (CS).

The means of the δ2H and δ18O for the CS are −4.76‰ and −35.2‰ as shown in Table 1.

TABLE 1
Isotopic values of control subject's blood plasma.

| | | | | | | | | |
|---|---|---|---|---|---|---|---|---|
| | | | | | | eGFR | | |
| | | | | | | (mL/ | | |
| | | | | BUN | Creat | min/ | | |
| | | Sampling | | (mg/ | (mg/ | 1.73 | δ¹⁸O | δ²H |
| CS^{a, b} | Sex | Date | Age | dL)^{c} | dL)^{d} | m²)^{e} | (‰)^{f} | (‰)^{f} |

Fasting Sample (CS)^{h}

| | | | | | | | | |
|---|---|---|---|---|---|---|---|---|
| 1 | F | December | 39 | 11.0 | 0.7 | 99.54 | −5.87 | −37.1 |
| | | 2009 | | | | | | |
| 2 | F | December | 43 | 15.0 | 0.6 | 116.52 | −4.22 | −31.5 |
| | | 2009 | | | | | | |
| 3 | M | December | 45 | 15.0 | 0.7 | 96.62 | −5.02 | −34.5 |
| | | 2009 | | | | | | |
| 4 | M | December | 30 | 14.0 | 0.7 | 134.14 | −4.37 | −34.8 |
| | | 2009 | | | | | | |
| 5 | F | December | 41 | 7.0 | 0.6 | 117.68 | −4.34 | −38.1 |
| | | 2009 | | | | | | |

Mean (std.)ⁱ

| | | | | | | |
|---|---|---|---|---|---|---|
| CS | 40 | 12.4 | 0.66 | 112.9 | −4.76 | −35.2 |
| | (5.8) | (3.4) | (0.05) | (15.3) | (0.7) | (2.6) |

^{a}The 5 human blood plasma samples (CS-1 to CS-5) were collected from the control subjects with healthy kidney.
^{b}All control subjects are inside the country without traveling three months prior to sample.
^{c}The blood urea nitrogen (BUN) test is to evaluate the renal function by measuring the amount of nitrogen in the form of urea in blood. The normal level of urea in blood is 7-20 mg/dL.
^{d}The creatinine is the metabolite of creatine. The creatinine test is used as an indicator of renal function. The normal level of creatinine in blood is 0.7-1.2 mg/dL for male, and 0.5-1.9 mg/dL for female [45].
^{e}The estimation of Glomerular filtration rate, an index of renal function. The eGFR value is calculated based on the MDRD (Modification of Diet in Renal Disease) formula, eGFR = 186 × serium creatinine^{-1.154} × age^{-0.203} × (1.212 if black) × (0.742 if female)[46].
^{f}The ratio is reported as the δ-notation (‰) relative to the international V-SMOW (Vienna Standard Mean Ocean Water) standard and normalized on the scale that the δ¹⁸O and δ²H of SLAP (Standard Light Antarctic Precipitation) are −55.5 ‰ and −428 ‰, respectively [44].
ⁱThe numbers in the parenthesis are the standard deviations taken all numbers of each group.

### The End Stage Renal Disease Group (ESRD).

The mean values of δ²H and δ¹⁸O for the ESRD_{nHD} are −11.89‰ and −72.44‰, and are −10.37‰ and −59.10‰ for the ESRD_{HD} (Table 2). The ESRD_{HD} (std. 2.9 for δ¹⁸O and 11.54 for δ²H) is more scattered than the ESRD_{nHD} (std. 0.9 for δ¹⁸O and 4.9 for δ²H) (FIG. 1). In terms of δ²H, the difference between the ESRD_{HD} and ESRD_{nHD} are significant [t_{0.05; 30}=2.5 and F_{005; 1.30}=6.33]. However for the δ¹⁸O, the difference is insignificant [t_{0.05; 30}=1.17 and F_{0.05; 1.30}=1.37].

TABLE 2
Isotopic values of end stage renal disease (ESRD) patient's blood plasma.

| | | | | | | | | | | | |
|---|---|---|---|---|---|---|---|---|---|---|---|
| | | | | | | eGFR | | | | | |
| | | Sampling | | BUN | Creat | (mL/min/ | Na⁺ | K⁺ | Cl⁻ | δ¹⁸O | δ²H |
| ESRD^{a} | Sex | Date | Age | (mg/dL)^{b} | (mg/dL)^{c} | 1.73 m²)^{d} | (mmol/L)^{e} | (mmol/L)^{f} | (mmol/L)^{g} | (‰)^{h} | (‰)ⁱ |

No Haemodialysis treatment (ESRD_{nHD})^{j}

| | | | | | | | | |
|---|---|---|---|---|---|---|---|---|
| 1 | F | September | 65 | 40.0 | 1.9 | 28.29 | −12.59 | −78.6 |
| | | 2009 | | | | | | |
| 2 | M | September | | 77.0 | 4.8 | 12.24 | −12.55 | −76.6 |
| | | 2009 | | | | | | |
| 3 | F | September | 71 | 92.0 | 5.9 | 10.12 | −12.31 | −67.4 |
| | | 2009 | | | | | | |
| 4 | M | September | 82 | 42.0 | 2.2 | 30.69 | −11.61 | −69.1 |
| | | 2009 | | | | | | |
| 5 | M | September | 70 | 64.0 | 2.8 | 23.93 | −10.39 | −70.5 |
| | | 2009 | | | | | | |

Haemodialysis treatment (ESRD_{HD})^{k}

| | | | | | | | | | | | |
|---|---|---|---|---|---|---|---|---|---|---|---|
| 6 | F | July | | | | | | | | −11.31 | −78.9 |
| | | 2008 | | | | | | | | | |
| 7 | F | July | | | | | | | | −11.41 | −82.1 |
| | | 2008 | | | | | | | | | |
| 8 | F | March | 54 | 82.0 | 11.5 | 3.69 | 141 | 4.9 | 96 | −15.95 | −72.3 |
| | | 2009 | | | | | | | | | |
| 9 | M | March | 62 | 87.0 | 9.8 | 5.82 | 135 | 6.5 | 97 | −15.08 | −73.8 |
| | | 2009 | | | | | | | | | |
| 10 | M | March | 69 | 31.07 | 13.5 | 3.94 | 136 | 4.1 | 94 | −14.37 | −69 |
| | | 2009 | | | | | | | | | |
| 11 | M | March | 60 | 69.0 | 12.5 | 4.44 | 140 | 4.5 | 100 | −14.24 | −73.4 |
| | | 2009 | | | | | | | | | |
| 12 | F | March | 77 | 38.0 | 5.2 | 8.57 | 139 | 2.4 | 95 | −13.45 | −71.1 |
| | | 2009 | | | | | | | | | |
| 13 | M | March | 53 | 80.0 | 11.7 | 4.9 | 137 | 4.9 | 98 | −13.3 | −65.1 |
| | | 2009 | | | | | | | | | |
| 14 | M | March | 84 | 55.0 | 9.1 | 5.96 | 135 | 4.4 | 97 | −12.12 | −55.3 |
| | | 2009 | | | | | | | | | |
| 15 | M | March | 64 | 82.0 | 9.9 | 5.71 | 134 | 5.2 | 97 | −11.95 | −70.6 |
| | | 2009 | | | | | | | | | |
| 16 | M | March | 74 | 113.0 | 10.1 | 5.43 | 137 | 5.8 | 94 | −11.00 | −52.6 |
| | | 2009 | | | | | | | | | |
| 17 | F | March | 46 | 73.0 | 10.4 | 4.29 | 135 | 5.4 | 98 | −10.66 | −49.7 |
| | | 2009 | | | | | | | | | |
| 18 | F | March | 64 | 70.0 | 8.1 | 5.34 | 125 | 3.6 | 90 | −10.56 | −60.2 |
| | | 2009 | | | | | | | | | |
| 19 | M | March | 79 | 65.0 | 9.0 | 6.12 | 133 | 4.5 | 97 | −10.31 | −57.9 |
| | | 2009 | | | | | | | | | |
| 20 | F | March | 76 | 51.0 | 7.0 | 6.12 | 136 | 4.2 | 97 | −9.77 | −58.8 |
| | | 2009 | | | | | | | | | |
| 21 | M | March | 81 | 51.0 | 8.4 | 6.59 | 138 | 3.1 | 99 | −9.61 | −63.3 |
| | | 2009 | | | | | | | | | |
| 22 | M | March | 38 | 120.0 | 16.0 | 3.69 | 138 | 5.0 | 97 | −9.31 | −54.6 |
| | | 2009 | | | | | | | | | |
| 23 | F | March | 94 | 86.0 | 6.3 | 6.60 | 128 | 5.1 | 9 | −9.29 | −53.0 |
| | | 2009 | | | | | | | | | |
| 24 | M | March | 46 | 85.0 | 11.2 | 5.33 | 135 | 4.4 | 92 | −9.27 | −54.6 |
| | | 2009 | | | | | | | | | |
| 25 | M | March | | | | | | | | −8.89 | −53.0 |
| | | 2009 | | | | | | | | | |
| 26 | F | March | 55 | 62.0 | 8.6 | 5.15 | 136 | 5.3 | 96 | −8.06 | −56.1 |
| | | 2009 | | | | | | | | | |
| 27 | M | March | 85 | 19.0 | 7.9 | 7.00 | 132 | 5.9 | 100 | −7.93 | −45.5 |
| | | 2009 | | | | | | | | | |
| 28 | F | March | 77 | 78.0 | 5.7 | 7.71 | 137 | 4.2 | 97 | −7.78 | −49.4 |
| | | 2009 | | | | | | | | | |
| 29 | M | March | 63 | 66.0 | 12.5 | 4.38 | 139 | 4.8 | 99 | −7.60 | −45.4 |
| | | 2009 | | | | | | | | | |
| 30 | F | March | 60 | 93.0 | 10.0 | 4.26 | 135 | 3.9 | 93 | −5.74 | −48.3 |
| | | 2009 | | | | | | | | | |
| 31 | M | March | 86 | 105.0 | 11.7 | 4.44 | 131 | 5.2 | 94 | −5.60 | −41.7 |
| | | 2009 | | | | | | | | | |
| 32 | M | March | 66 | 95.0 | 12.3 | 4.42 | 135 | 5.1 | 97 | −5.44 | −40.1 |
| | | 2009 | | | | | | | | | |

Mean (std.)¹

| | | | | | | | | | |
|---|---|---|---|---|---|---|---|---|---|
| ESRD_{nHD} | 72 (7.1) | 63.0 | 3.5 | 21.05 | | | | −11.89 | −72.4) |
| | | (22.4) | (1.7) | (9.36) | | | | (0.9) | (4.9) |
| ESRD_{HD} | 67 (14) | 73.2 | 9.9 | 5.41 | 135 (4) | 5.0 | 92 (18) | −10.37 | −59.1 |
| | | (24.6) | (2.6) | (1.27) | | (1.0) | | (2.9) | (11.5) |

^{a}32 human blood plasma samples were collected from ESRD (End stage renal disease) patients, fasting for 8 hours, and are subjected into two groups, ESRD_{nHD} (end stage renal disease yet with no haemodialysis treatment) and ESRD_{HD} (end stage renal disease with receiving haemodialysis treatment).
^{b, c, d}The BUN, Creat, and eGFR test, all is the indicator for renal function; see Table 1 footnotes c, d, and e.
^{e}The concentration of sodium in blood. The normal level of sodium in blood is 135-140 mmol/L.
^{f}The concentration of potassium in blood. The normal blood potassium level is 3.5-5 mmol/L.
^{g}The concentration of chloride in blood. The normal range for chloride in blood is 98-108 mmol/L.
^{h, i}The isotope ratio is reported as the δ-notation (‰), see details in Table 1 footnotes c and d.
^{j}ESRD_{nHD} samples (ESRD-1 to ESRD-5) were collected from the ESRD patients who have not yet been the haemodialysis treatment. The ESRD_{nHD} did not perform the monovalent ion test.
^{k}ESRD_{HD} samples (ESRD-6 to ESRD-32) were collected from the ESRD patients who are receiving haemodialysis over 6 months. These samples were collected right before the ESRD patients to receive the haemodialysis.
^{l}The numbers in the parenthesis are the standard deviations taken all numbers of each group.

### The Diabetes Group (DB)

In the DB group, the mean of δ²H in blood plasma is −4.04‰, and is −34.08‰ for the δ¹⁸O (Table 3).

TABLE 3
Isotopic values of diabetes (DB) patient's blood plasma

| | | | | | eGFR | | | |
|---|---|---|---|---|---|---|---|---|
| | | | Sampling | Creatinine | (mL/min/ | glucose | δ¹⁸O | δ²H |
| DB^{a} | Sex | Age | Date | (mg/dL)^{b} | 1.73 m²)^{c} | (mg/dL)^{d} | (‰)^{e} | (‰)^{f} |
| 1 | F | 61 | December | 0.6 | 108.38 | 198 | −4.11 | −36.1 |
| | | | 2009 | | | | | |
| 2 | F | 74 | December | 0.5 | 128.54 | 102 | −4.25 | −28.1 |
| | | | 2009 | | | | | |
| 3 | F | 76 | December | 0.6 | 103.58 | 153 | −4.14 | −38.7 |
| | | | 2009 | | | | | |
| 4 | F | 70 | December | 0.8 | 75.81 | 181 | −3.50 | −29.3 |
| | | | 2009 | | | | | |
| 5 | M | 61 | December | 1.0 | 81.01 | 170 | −4.18 | −38.2 |
| | | | 2009 | | | | | |

| | | | | | | |
|---|---|---|---|---|---|---|
| Mean | 68.4 | 0.7 | 99.46 | 160.8 | −4.04 | −34.08 |
| (std.)^{g} | (7.1) | (0.2) | (21.46) | (36.7) | (0.3) | (5.0) |

^{a}The DB blood plasma samples (DB-1 to DB-5) were collected from the diabetes patients, fasting for 8 hours.
^{b}The plasma creatinine concentration, an indicator of renal function.
^{c}The estimation of Glomerular filtration rate, an index of renal function. See Table 1 footnote e for details.
^{d}Fasting blood glucose level.
^{e, f}The isotope ratio is reported as the δ-notation (‰), see details in Table 1 footnotes c and d.
^{g}The numbers in the parenthesis are the standard deviations taken all numbers of DB.

The Water δ¹⁸O and δ²H Values of the ESRD are Distinctively Lower than Those of the CS.

The values of water δ¹⁸O and δ²H in the blood plasma of the ESRD_{nHD} showed distinct characteristics from those of the CS. By applying the Student's t-test and the ANOVA statistical analysis to the ESRD_{nHD} and the CS datasets, the water contents (δ¹⁸O and δ²H) of the blood plasma in the ESRD_{nHD} and the CS showed significant difference [t_{0.05; 8}=13.78 and F_{0.05; 1.8}=189.83 for δ¹⁸O; t_{0.05; 8}=15.08 and F_{0.05; 1.8}=227.47 for δ²H]. The distributions of the δ¹⁸O and δ²H in blood plasma of the ESRD_{HD} were scattered between the CS and the ESRD_{nHD}. The δ¹⁸O and δ²H in the blood plasma water of the ESRD_{HD} are also significantly lower than those of the CS. The δ¹⁸O and δ²H in blood plasma of ESRD (including ESRDnHD and ESRD_{HD}) are 87% and 72% lower than the CS and are 160% and 92% lower than the DB. Thus, the values of δ¹⁸O and δ²H in blood plasma correlate with renal function in the present study. The lowered level of water ¹⁸O and ²H in the blood plasma of the ESRD patients are intriguing, since both the normal control subjects and renal patients share the same source of drinking and dietary water.

It seems that the ²H and ¹⁸O isotopes are being selectively “removed” from the water of blood plasma in patients with renal dysfunction. One of the many functions of kidney is the reabsorption of water, which is now known, at least in part, mediated by different types of renal aquaporins (AQPs), a plasma membrane protein that forms water channel (Nielsen S, Frokiaer J, Marples D, Kwon T H, Agre P, et al. (2002) Aquaporins in the kidney: from molecules to medicine. Physiological Reviews 82: 205-244; King L S, Kozono D, Agre P (2004) From structure to disease: The evolving tale of aquaporin biology. Nature Reviews Molecular Cell Biology 5: 687-698; Borgnia M, Nielsen S, Engel A, Agre P (1999) Cellular and molecular biology of the aquaporin water channels. Annual Review of Biochemistry 68: 425-458). For example, aquaporin 1 (AQP1) is localized at the proximal tubules, and descending thin limb that increases the water permeability (Nielsen S, Smith B L, Christensen E L Knepper M A, Agre P (1993) CHIP28 water channels are localized in constitutively water-permeable segments of the nephron. The Journal of cell biology 120: 371-383). The AQP2, AQP3, and AQP4 are localized at the collecting duct, where AQP2 is a vasopressin regulation target for the water permeability at the collecting duct (Nielsen S, Knepper M A (1993) Vasopressin activates collecting duct urea transporters and water channels by distinct physical processes. The American journal of physiology 265: F204-213). Questions naturally arise whether or not these aquaporin proteins involve in the lower level of ¹⁸O and ²H in blood plasma in renal dysfunction patients. In a previous study, the molecular dynamics (MD) simulation and solution experiment of the prototypical AQP1 show that the permeability of ²H₂O is similar to that of water (Mamonov A B, Coalson R D, Zeidel M L, Mathai J C (2007) Water and deuterium oxide permeability through aquaporin 1: MD predictions and experimental verification. The Journal of general physiology 130: 111-116), while another study shows that point mutation in the aromatic/arginine region of AQP1 allows protons pass through it (Beitz E, Wu B, Holm L M, Schultz J E, Zeuthen T (2006) Point mutations in the aromatic/arginine region in aquaporin 1 allow passage of urea, glycerol, ammonia, and protons. Proceedings of the National Academy of Sciences of the United States of America 103: 269-274). Moreover, in the ESRD patients, a higher concentration of vasopressin is found (Argent N B, Baylis P H, Wilkinson R (1990) Immunoreactive vasopressin in end stage renal failure. Clinica chimica acta; international journal of clinical chemistry 190: 185-188). Vasopressin and water deprivation accompany upregulation of AQP2 in renal collecting duct (Terris J, Ecelbarger C A, Nielsen S, Knepper M A (1996) Long-term regulation of four renal aquaporins in rats. The American journal of physiology 271: F414-422; Combet S, Gouraud S, Gobin R, Berthonaud V, Geelen G, et al. (2008) Aquaporin-2 downregulation in kidney medulla of aging rats is posttranscriptional and is abolished by water deprivation. American Journal of Physiology—Renal Physiology 294: F1408-F1414), and downregulation of AQP2 in aging is posttranscriptional (Combet S, Gouraud S, Gobin R, Berthonaud V, Geelen G, et al. (2008) Aquaporin-2 downregulation in kidney medulla of aging rats is posttranscriptional and is abolished by water deprivation. American Journal of Physiology—Renal Physiology 294: F1408-F1414). Further investigation on the level of monovalent ions such as Na⁺, K⁺, and Cl⁻ in blood plasma of ESRD_{HD} revealed that the normal functioning of active transport of ascending limb of the loop of Henle (Table 2), whereas this part of the nephron contains no aquaporins (Nielsen S, Frokiaer J, Marples D, Kwon T H, Agre P, et al. (2002) Aquaporins in the kidney: from molecules to medicine. Physiological Reviews 82: 205-244; King L S, Kozono D, Agre P (2004) From structure to disease: The evolving tale of aquaporin biology. Nature Reviews Molecular Cell Biology 5: 687-698). Therefore, study the physiological role of ESRD's aquaporins in stable isotopes, at both systematic and atomic resolutions, may elucidate the hypo heavy water in the renal dysfunction patients.

### The Homeostasis of ¹⁸O and ²H of Blood Plasma Resists the Fluctuation of ¹⁸O and ²H Levels of Water Sources.

The δ²H and δ¹⁸O values of the rain precipitation fluctuate seasonally. Since the majority of water ²H and ¹⁸O in the blood plasma would eventually come from the rain precipitation-the source of the drinking and dietary water, it would be interesting to examine the relationships between the δ²H and δ¹⁸O values in the rain water and the plasma water.

The δ²H and δ¹⁸O values of the data with those of Taipei monthly precipitation from 2000 to 2010 was compared (Peng T-R, Wang C-H, Huang C-C, Fei L-Y, Chen C-T A, et al. (2010) Stable isotopic characteristic of Taiwan's precipitation: A case study of western Pacific monsoon region. Earth and Planetary Science Letters 289: 357-366). From January to May, the δ²H and δ¹⁸O values of the rain water showed little variation. These values started to drop in the June, reaching the minimum in the July and August and climbing back from the September to December. On the other hand, the plasma water isotope ratios in the CS group were always lower than those of the rain precipitation from January to May. However, the isotope ratios of plasma water were in the standard error of rain precipitation from July to December. Therefore, a homeostasis of isotope δ²H and δ¹⁸O in the blood plasma of CS group was observed to against the fluctuation of daily intake water.

Due to frequent typhoons in July of Taiwan, the isotope content of rain precipitation was least but varies most among all other months. The isotope ratios of plasma water of ESRD_{HD} in July and March are significant lower than that of precipitation, again indicates a strong independency of rain water. Although the isotope ratio of precipitation in September is close to that of CS, the same manner remains observed in ESRD_{nHD}, about 35% lower than that of the precipitation. For the DB group, the δ¹⁸O of plasma water is comparable to that of rain precipitation in December [t_{0.05; 14}=0.27 and F_{0.05; 1.14=0.07]}, but the δ²H of plasma water shows the independency of rain precipitation [t_{0.05; 14}=3.03 and F_{0.05; 1.14}=9.21].

### The Water δ¹⁸O and δ²H Values in the DB and the CS Groups are Similar.

The values of the δ¹⁸O and δ²H from the DB are similar to those of the CS. The ANOVA analysis suggests that the plasma water content (δ¹⁸O and δ²H) of the DB and the CS are comparable [F0.05; 1.8=4.63 for δ18O; F0.05; 1.8=0.20 for δ2H].

It appears that there is a fine tune of the biological homeostasis of water isotopes reflecting differential renal conditions. For example, the ESRD_{nHD} and the normal renal groups (the CS and the DB) have different homeostasis levels. Note that the three groups with normal renal function (Tables 1 and 3), the δ¹⁸O and δ²H levels of the CS and DB are similar. In addition, we notice that the age of the CS subject (range from 27 to 67 yr.) is independence of the DB and ESRD subjects (p=0). The lack of the ¹⁸O and ²H homeostasis in the ESRD_{HD} group could be due to the times and durations of each haemodialysis, and the hydration status of different ESRD_{HD} subjects (Konings C J, Kooman J P, Schonck M, Cox-Reijven P L, van Kreel B, et al. (2002) Assessment of fluid status in peritoneal dialysis patients. Pent Dial Int 22: 683-692).

The causes of renal dysfunction are usually very complicated, including medications, diabetes mellitus, hypertension, sepsis, personal life style, and so on. Nonetheless, an impaired kidney causes the accumulation of metabolites, which results in the replacement of ²H for ¹H and ¹⁸O for ¹⁶O. This would eventually lead to the hypo isotope of blood plasma. In the present study, we suggest that the renal dysfunction is associated with the much reduced δ¹⁸O and δ²H in human blood plasma. It was observed that a signature of hypo isotope of blood plasma exhibits in renal dysfunction patients but not in healthy persons or diabetes patients. The data and results suggest that the δ¹⁸O and δ²H of blood plasma is sensitive to the renal function but seems insensitive to age, race and diet, probably due to the biological isotope homeostasis. In sum, this pilot study along with biological data suggests the possibility of using level of δ¹⁸O and δ²H in blood plasma as a potential marker for renal dysfunction.

What is claimed is:

1. A method for diagnosing likelihood of a renal disease in a subject suspected of the renal disease, comprising: measuring a value of delta O-18 (δ¹⁸O) and/or delta H-2 (δ²H) in a biological sample of the subject suspected of the renal disease, comparing the measured value of delta O-18 and/or delta H-2 with a reference value of delta O-18 and/or delta H-2 obtained from a subject without a renal disease; and diagnosing the likelihood of a renal disease based on the comparison of the measured value of delta O-18 and/or delta H-2 with the reference value of delta O-18 and/or delta H-2, wherein the likelihood of a renal disease is diagnosed when the value of delta O-18 and/or delta H-2 in the biological sample of the subject suspected of the renal disease is lower than the reference value of delta O-18 and/or delta H-2 obtained from a subject without a renal disease.

2. The method of claim 1, wherein the reference value of the delta O-18 obtained from a subject without a renal disease ranges from about −3‰ to about −7‰.

3. The method of claim 1, wherein the reference value of the delta O-18 obtained from a subject without a renal disease ranges from about −3‰ to about −6‰, about −4‰ to about −7‰, about −4‰ to about −6‰, about −4‰ to about −5‰ or about −4.5‰ to about −5‰.

4. The method of claim 1, wherein the reference value of the delta H-2 obtained from a subject without a renal disease ranges from about −30‰ to about −40‰, about −30‰ to about −39‰, about −30‰ to about −38‰, about −30‰ to about −37‰, about −30‰ to about −36‰, about −30‰ to about −45‰, about −31‰ to about −40‰, about −32‰ to about −40‰, about −32‰ to about −37‰ or −33‰ to about −37‰.

5. The method of claim 1, wherein the reference value of the delta H-2 obtained from a subject without a renal disease is about −35‰

6. The method of claim 1, wherein the value of the delta O-18 of the subject with a renal disease is lower than about −3‰, about −4‰, about −5‰, about −6‰, about −7‰

7. The method of claim 1, wherein the value of the delta O-18 of the subject with a renal disease is lower than about −3‰ to about −7‰.

8. The method of claim 1, wherein the value of the delta O-18 of the subject with a renal disease is lower than about −3‰ to about −6‰, about −4‰ to about −7‰, about −4‰ to about −6‰, about −4‰ to about −5‰ or about −4.5‰ to about −5‰.

9. The method of claim 1, wherein the value of the delta O-18 of the subject with a renal disease is about −3‰ to about −18‰, about −4‰ to about −18‰, about −5‰ to about −18‰, about −6‰ to about −18‰, about −7‰ to about −18‰, about −4‰ to about 17‰, about −5‰ to about −17‰, about −6‰ to about −17‰, about −7‰ to about −17‰.

10. The method of claim 1, wherein the value of the delta H-2 of the subject with a renal disease is lower than about −30‰, about −31‰, about −32‰, about −33‰, about −34‰, about −35‰, about −36‰, about −37‰, about −38‰, about −39‰, or about −40‰.

11. The method of claim 1, wherein the value of the delta H-2 of the subject with a renal disease is lower than −30‰ to about −40‰, about −30‰ to about −39‰, about −30‰ to about −38‰, about −30‰ to about −37‰, about −30‰ to about −36‰, about −30‰ to about −35‰, about −31‰ to about −40‰, about −32‰ to about −40‰, about −32‰ to about −37‰ or −33‰ to about −37‰.

12. The method of claim 1, wherein the value of the delta H-2 of the subject with a renal disease is about −30‰ to about −85‰, about −30‰ to about −80‰, about −30‰ to about −75‰, about −30‰ to about −70‰, about −30‰ to about −65‰, about −30‰ to about −60‰, about −30‰ to about −55‰, about −30‰ to about −50‰, about −30‰ to about −45‰, about −30‰ to about −40‰, about −31‰ to about −80‰, about −32‰ to about −80‰, about −33‰ to about −80‰, about −34‰ to about −80‰, about −35‰ to about −80‰, about −35‰ to about −75‰, about −40‰ to about −80‰ or about −40‰ to about −75‰.

13. The method of claim 1, wherein the biological sample is body fluid.

14. The method of claim 13, wherein the body fluid is urine, blood, serum, plasma, saliva, lymph, cerebrospinal fluid, cystic fluid, ascites, stool, bile or tissue fluid.

15. The method of claim 13, wherein the body fluid is blood plasma.

16. The method of claim 1, wherein the biological sample is treated by placing the sample into a sealed container with a desiccant and then removing the water from the hydrated desiccant to obtain water for the measurement of the value of delta O-18 (δ¹⁸O) or delta H-2 (δ²H).

17. The method of claim 16, wherein the removal of the water from the hydrated desiccant is through distillation or vacuum distillation.

18. The method of claim 16, wherein the desiccant is selected from the group consisting of silica gel, activated charcoal, calcium sulfate, calcium chloride, montmorillonite clay, and molecular sieves.

19. The method of claim 1, wherein the renal disease is end stage renal disease (ESRD), nephropathy, renal failure, hyperuricemia, diabetic kidney disease, ischemic or toxicant-induced renal injury, chronic renal failure, acute renal failure, glomerulonephritis, polycystic kidney disease or chronic pyelonephritis.

20. A kit for carrying out the method of claim 1, said kit comprising: a vessel containing a biological sample from a subject potentially suffering from a renal disease or who runs the risk of a renal disease, or a vessel assumed to be filled with this sample, a means for measuring the value of the delta O-18 or delta H-2 in a biological sample, and a reference value means for enabling the diagnosis of a renal disease.

21. The kit of claim 20, which further comprises a vessel containing a desiccant.

22. The kit of claim 21, wherein the desiccant is selected from the group consisting of silica gel, activated charcoal, calcium sulfate, calcium chloride, montmorillonite clay, and molecular sieves.
